(19) United States
(12) Patent Application Publication
(10) Pub. No.: US 2019/0251619 A1
(43) Pub. Date: Aug. 15, 2019

(54) APPARATUSES, SYSTEMS, AND METHODS FOR IN STORE SHOPPING

(71) Applicant: Diebold Nixdorf Incorporated, North Canton, OH (US)

(72) Inventors: David William KUCHENSKI, Tallmadge, OH (US); Germen Schuiling, Harderwijk (NL)

(21) Appl. No.: 16/343,755

(22) PCT Filed: Oct. 23, 2017
(86) PCT No.: PCT/US17/57883

§ 371 Date: Apr. 20, 2019

Related U.S. Application Data
(60) Provisional application No. 62/411,267, filed on Oct. 21, 2016.

(51) Int. Cl. G06Q 30/06; G06Q 20/32

(52) U.S. Cl. CPC G06Q 30/0639; G06Q 20/322; G06Q 30/0635

(57) ABSTRACT

A server is associated with a retailer having a store. The server has a processor, communication device, and other logic devices. The processor receives an electronic list from a mobile device carried by the user. The communication device communicates with the mobile device. A product locator logic locates items from the electronic list in the store and route determination logic finds a route traveling past the items in the electronic list. An upsell logic may upsell some items when they are scanned. A warning logic generates a warning message for display on the mobile device when the user is allergic to an ingredient in the item. A checkout logic sums all scanned items and uses payment information provided by the mobile device to processes payment of the items. The mobile device optionally displays the route within a map of the store to allowing the user to find the electronic list.

### CROSS-REFERENCE TO RELATED APPLICATIONS

This application claims priority to and the benefit of U.S. Provisional Application No. 62/411,267, filed Oct. 21, 2016, the contents of which are hereby incorporated by reference in their entirety.

### BACKGROUND

This relates in general to shopping for goods and/or services.

Many consumers visit many differing types of shopping places, such as supermarkets or superstores, when shopping for a variety of products, such as groceries, office supplies, and household wares, among many products. These stores may have many aisles or sections. Consumers generally traversing these aisles and sections looking for specific products. In some instances, there may be signage, but typically, it is arranged such that consumers must traverse from sign to sign. Moreover, the signage may be overly specific and/or overly broad as not to clear convey the location of specific items being sought. It is known that some consumers may use a digital shopping list in order to better organize and remember their items when preparing to go shopping. However, unless the consumer has sufficient knowledge of the location of items in the store and sufficient recall of such knowledge, the consumer will likely be faced with the prospect of repeatedly crossing aisles during shopping or visiting the same regions of a stores multiple times.

### SUMMARY

This relates more particularly, to apparatus, systems, and methods for assisting a consumer with in-store shopping. For example, apparatuses, systems, and methods may assist a consumer in finding and/or purchasing goods and/or services within a retail establishment.

At least one embodiment includes a system for assisting a customer/user shopping for items in a retail store. The system includes a server associated with a retailer and may have any one of or combination of a processor, communication device, product locator logic, route determination logic, upsell logic, warning logic, and checkout logic. The processor receives an electronic list from a mobile device carried by the user. The communication device communicates with the mobile device. The product locator logic locates items from the electronic list in the store. The route determination logic finds a route traveling past the items in the electronic list. The upsell logic upsells the user depending on what products the user has scanned with the mobile device. The warning logic generates warning messages for display on the mobile device when the user is allergic to an ingredient in the item. The checkout logic sums all scanned items and uses payment information provided by the mobile device to processes payment of the items. The mobile device optionally displays the route within a map of the store to allowing the user to find the electronic list.

### BRIEF DESCRIPTION OF THE DRAWINGS

FIG. 1 is a schematic illustration a mobile device in communication with a server.

FIG. 2 is a schematic illustration of components of the mobile device of FIG. 1.

FIG. 3 is a schematic illustration of an electronic-shopping list having product waypoint descriptions displayed by the mobile device of FIG. 1.

FIG. 4 is a map having a plurality of waypoints and a best route displayed.

FIG. 5 is a schematic illustration of the shopping list server of FIG. 1.

FIG. 6 is a flow chart illustrating a method for determining a plurality of waypoints based on items contained in an electronic-shopping list.

FIG. 7 is a flow chard illustrating a method of assisting a user/customer purchasing items in a retail store.

FIG. 8 is a schematic illustration of logic implementation.

FIG. 9 is a schematic app flow for building a list.

FIG. 10 is a schematic app flow for shopping and scanning items for purchase.

FIG. 11 is a schematic app flow for checkout and payment for items.

FIGS. 12A-11K are schematic representations of a user interface for a mobile device in various stages of a shopping experience.

### DETAILED DESCRIPTION

One embodiment is a mobile-enabled shopping experience that starts at home that may utilize voice services or other services to build an electronic-shopping list. For example, the shopping list may be created with a user/customer's mobile phone using an application such as Wunderlist or any suitable application for creating an electronic list. Alternatively, or in addition to the list creation software a specific retailer's shopping application may be used in creating the shopping list and also later used when purchasing items at the corresponding merchant's store. Retailers that may create list building and shopping applications may include, for example, department stores, supermarkets, grocery stores, and/or other retailers. In some embodiments, when a specific retailer's application is being used, or a retailer has been given access to a list, the retailer may receive and/or view the list before the consumer gets to their store. This allows the retailer to make sure items on the list are in stock and displayed for purchase and may allow the retailer to determine that many customers all plan to buy the same item. For example, if by monitoring customer lists it is determined that 20 or more users are planning to buy milk within a curtain timeframe then the retailer may want to stock up and/or order milk for those sales.

In another embodiment, a retailer may know customer's buying habits so the retailer may help customers to plan three lunches and five dinners this week as requested by customer. Automatically (store software) or manually Fill meal description with recipes and/or recipes of the internet. Retailer may up-sale, while a customer is creating lists and before they arrive at the store and when they are still in the store.

Once the electronic list is created and/or the customer desires to go to the store, software running in the mobile device (e.g., mobile electronic device) with the list or a server associated with the store may direct the customer to the nearest store. While in the store, the customer may use an application in their mobile device and/or software running on a server associated with the store to have their mobile device display a map of the store showing where items in their electronic list are located. Additionally, the mobile device aided by software may also display a path of a best/shortest route to travel to collect the items as efficiently as possible. In some embodiments, item located near each other may be grouped together and propagated to the top of the list when the customer is near those items to prevent the customer from entering or going back-and-forth one or more areas/departments of the store multiple times. For example, if the customer is in the produce section, then the produce items in the list are moved to the top of the list so that the customer may efficiently collect the desired produce items before leaving the produce section.

The customer may additionally scan each product before it is place in a shopping cart or shopping bag. For example the mobile device may use a Diebold Nixdorf product known as “TIP Shop” on a software platform to scan each product. It must be appreciated that any acceptable way of scanning items (e.g., products) may be used. A remote server associated with the retailer/store may keep track of items scanned into the cart/basket to provide for an efficient way to later pay/checkout when the customer is finished shopping.

In some example embodiments, when a user scans a product, the store may capture their location. The user's location may be captured using overhead store lighting signals that interacts with a mobile device (e.g., cellphone) and/or the mobile device's camera to determine where the consumer is located. For example, a customer may request information as to where saffron is located. In response, software may display a map on the mobile device indicating the user's current location and a line marking a route from that location to the saffron. In some configurations, it may be possible to request general “help” from the mobile device and to have the mobile device display a map of the user's current location as well as the location of one or more store associates that are near the user that may provide assistance.

The retailer may have ability to interface with the user's electronic list or to monitor what the user is scanning into their cart/basket so that the retailer may upsell the user. For example, when the retailer's computer system detects a toy has been scanned, the retailer may send a message to the user and/or the user's electronic list to inform the user that the toy that was scanned will need batteries and possibly ask whether batteries should be added to the electronic list. Alternatively, the retailer may detect that a meat product such as a steak was scanned and the retailer may alert the customer that the scanned steak may be on sale the next day or on a near future day. In some configurations, when a scan of an article of clothing is detected, the retailer computer system may provide information on the mobile device about matching clothing or other accessories related to the article of clothing that was scanned. It must be understood that there may be many other upselling opportunities.

In alternate configurations, the retail computer system may provide warnings to a customer. For example, the mobile device may be preloaded with substances a user or their family is allergic to such as dairy products and share this information with the retail computer system. Later when a customer scans an item containing a dairy product or another item that they are allergic to, the computer system may provide a warning to the user through the mobile device. It must be understood that many other scenarios where the user may want to be warned when certain products are scanned.

Because everything has been pre-scanned as it is placed in the user's cart, basket, or the like, payment when the user's shopping is complete may be greatly simplified without requiring sales personal overseeing the checkout process. In one embodiment, the mobile device may sum all the items that were scanned as they are scanned or when a user signals he/she is finished shopping. A user may have earlier upload his credit card account information or other banking account information and onto their mobile device and/or a banking computer system to create “mobile wallet”. At a checkout terminal or a point of sale (POS), the user may select a payment method by interacting with their mobile device and then bring the mobile device into a near field communication (NFC) wireless signal and authorize payment using the selected credit card or other bank account. In other embodiments, they user may tap their mobile device on a Diebold-Nixdorf type of Irving ATM or a similar type of POS or checkout device to complete the payment to the retail establishment. It must be understood that there are other ways to process a payment after items/products have been previously scanned.

In some embodiments, there may be a need for one or more different security levels at the checkout location. For longtime very well known customers the retail establishment may allow those customers/user to check themselves out without a need for additional security. For other customers, there may be a need for a retail associated to verify a printed or electronic receipt showing a total number of items purchased with a total cost about and then quickly glance at the customer's cart or basket to verify the number of items appears correct and that the total cost of the items seems reasonable. The retail establishment may for some customers have an associate verify each item on the receipt matches each item in the customer's card or basket and that the cost of each item is correct. It must be appreciated that other different levels and types of security may be implemented. Returns, exchanges, and other after sale events of items are simplified because all the data, receipt, etc. about the item is conveniently already stored within the mobile device and, in some embodiments on a server associated with the retailer.

The embodiments discussed herein may use collaboration and data analytics to assist with solving challenges in purchasing environments. Diebold Nixdorf's advanced analytics capabilities are enabling financial institutions to have a complete view of the self-service channel and improve ATM and/or checkout machine uptime by anticipating maintenance needs. The embodiments described herein may also increase the mobility of banking or retail store staff to enable a financial institution or a retail store to strengthen relationships customers and some small and medium-sized businesses that they may transact business with. In summary, mobile device enablement is increasingly becoming the central extension of consumer's lives and is changing the way they shop and manage money. Thus, the embodiments discussed herein may leverage a mobile device to change the way consumers interact with financial institutions and retailers to drive the future of connected commerce.

The following includes apparatuses, methods, and/or computer program products. Accordingly, the following includes hardware embodiments, software embodiments (including firmware, resident software, micro-code, etc.), and combinations thereof that may be referred to herein as a “modules” or “systems.” Furthermore, the following includes computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CD-ROM), an optical storage device, and a magnetic storage device. Computer program code for carrying out operations disclosed may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Many consumers utilize their mobile devices to prepare electronic-shopping lists when preparing to shop for products. As used herein, the term “product” can refer to groceries, foods, office supplies, clothing wares, or any other fungible goods sold by a retailer. As used herein, the term “electronic-shopping list” can refer to any electronic representation of a shopping list that contains one or more items. As used herein, the term “item” can refer to any type of indicator of a product sold by a retailer. An item can refer to a generic product or a specific product. A generic product is a genus of product, e.g., eggs, milk, and bread. A specific product is a brand of product, e.g., PEPSI™, TUMS™, POP TARTS™. Furthermore, a specific product can also include a unitary amount, e.g., a 12 pack of PEPSI™. As used herein, the term “mobile device” can refer to any type of mobile devices, such as mobile telephones, laptop computers, and tablet computers, or stationary computing devices.

Techniques are disclosed herein for optimizing a mobile device user's shopping experience based on the electronic-shopping list. In particular, the techniques include determining a product waypoint for each product indicated in the electronic-shopping list and displaying the product waypoints to the user using, for example, the mobile device. As used herein the term “waypoint” can refer generally to a location in a store, e.g., a location of a product or an entrance. A waypoint can be represented in GPS coordinates, Cartesian coordinates, e.g., an (x, y) point if the store is divided into a Cartesian plane, and/or can be represented using reference points, e.g., “aisle 4, 50 feet from the front of the store.”

Furthermore, techniques are disclosed for determining a route for the user to take when shopping for the items in the electronic-shopping list. The techniques include determining product waypoints corresponding to each product indicated in the electronic-shopping list and determining an optimized route based on the waypoints. The route can be optimized to minimize or substantially minimize the amount of distance traveled or the amount of time to travel through the store. It should be appreciated that the route can be optimized for other criteria as well.

Additionally, techniques for grouping the items in electronic-shopping list are also disclosed. The items can be grouped based on the type of products and/or a section of the store where the products are located.

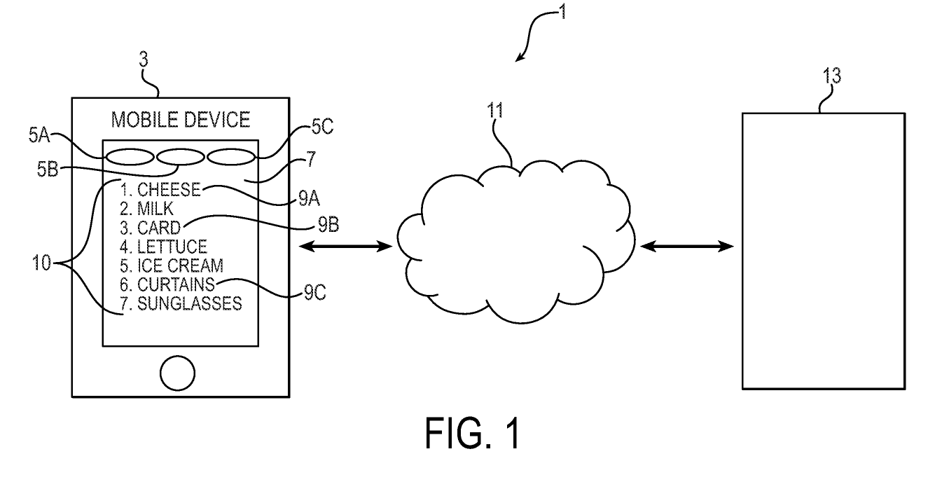

Referring now to FIG. 1, a system 1 includes a mobile device 3 in communication with a server 13 associated with a retailer via a network 11 is depicted. In some embodiments, the mobile device 3 is configured to allow a user to generate an electronic-shopping list 10 without needing a connection to the shopping list server 13. As shown in the illustrative example, the mobile device 3 is displaying a graphical user interface (GUI) 12 that is displaying an electronic-shopping list 10 comprised of a plurality of items, e.g., example item 9A, item 9B, and item 9C. The GUI 7 allows the customer (e.g., user) to add items to the electronic-shopping list. It should be appreciated that the mobile device 3 may obtain the electronic-shopping list 10 in any other suitable manner. For instance, a photograph of a handwritten shopping list can be captured using a digital camera and converted to an electronic-shopping list. In another example, the electronic-shopping list 10 can be uploaded from another source or can be learned from the user's purchasing habits.

The example GUI 7 of one embodiment further includes a plurality of input objects that allow the user to provide commands to the mobile device 3. The input objects include a “locate” input object 5A, a “list” input object 5B, and a “route” input object 5C.

In some embodiments the locate input object 5A, when selected by a user, initiates an instruction to the mobile device 3 to obtain product waypoints corresponding to each of the items in the electronic-shopping list. In response to receiving user input via the locate input object 5A, the mobile device 3 may determine a store at which the user intends to purchase the items and can send an indicator of the store and the electronic-shopping list 10 to the shopping list server 13. In some embodiments, the shopping list server 13 returns a product waypoint located on a map of the store corresponding to each item or some of the items in the electronic-shopping list, each product waypoint indicating a location of a product in the determined store. The mobile device 3 can display the product waypoints to the user via the GUI 7. In some embodiments, the product waypoints can be displayed in the electronic-shopping list 10 and/or in a map of the store at which the user intends to purchase the items.

The list input object 5B, when pressed by the user, initiates an instruction to the mobile device 3 to obtain a rearranged electronic-shopping list 10. The electronic-shopping list 10 may be rearranged based on the types of products indicated in the electronic-shopping list, the sections of the products indicated in the electronic-shopping list, or the locations of the products indicated in the electronic-shopping list. In response to receive user input via the list input object 5B the mobile device 3 may determine a store at which the user intends to purchase the products indicated in the electronic-shopping list 10 and can send an indicator of the store and the electronic-shopping list 10 to the shopping list server 13. In some embodiments, the shopping list server 13 returns an ordered electronic-shopping list 10 that is ordered according to the types, sections, and/or locations of the products. The mobile device 3 displays the ordered electronic-shopping list 10 in the GUI 7 that will be discussed in further detail below. Furthermore, in some embodiments, the shopping list server 13 returns product waypoints corresponding to the items in the ordered electronic-shopping list, such that the mobile device 3 displays the product waypoints in relation to their respective items.

The route input object 5C, when pressed by the user, initiates an instruction to the mobile device 3 to obtain an optimized route for the user to travel when shopping for the items in the electronic-shopping list. In response to receiving input via the route input object 5C, the mobile device 3 can determine a store at which the user intends to purchase the items and can send an indicator of the store and the electronic-shopping list 10 to the shopping list server 13. The shopping list server 13 can return a map of the store, waypoints corresponding to the items in the electronic-shopping list, and a route to recommend to the user. The mobile device 3 may display the map to the user, such that the waypoints and/or the route are displayed in the map.

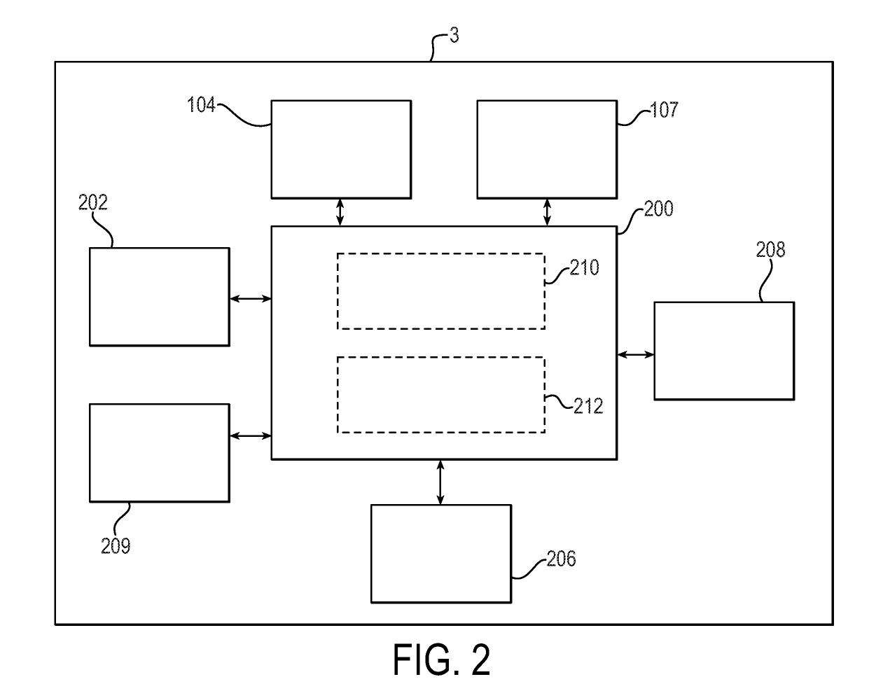

Referring now to FIG. 2, the mobile device 3 includes a processing device 200, a user interface 202, a communication device 204, a memory device 206, a global positioning system (GPS) 207, a camera 208, and a scanner 209. It is noted that the mobile device 3, in other embodiments, may include other components and some of the components are not required and in some embodiments the processing device may be a processor.

“Processor” and “Logic”, as used herein, includes but is not limited to hardware, firmware, software, and/or combinations of each to perform a function(s) or an action(s), and/or to cause a function or action from another logic, method, and/or system. For example, based on a desired application or need, logic and/or processor may include a software-controlled microprocessor, discrete logic, an application specific integrated circuit (ASIC), a programmed logic device, a memory device containing instructions or the like. Logic and/or processor may include one or more gates, combinations of gates, or other circuit components. Logic and/or a processor may also be fully embodied as software. Where multiple logics and/or processors are described, it may be possible to incorporate the multiple logics and/or processors into one physical logic (or processors). Similarly, where a single logic and/or processor is described, it may be possible to distribute that single logic and/or processor between multiple physical logics and/or processors.

The processing device 200 may include memory, e.g., read only memory (ROM) and random access memory (RAM), storing processor-executable instructions and one or more processors that execute the processor-executable instructions. In embodiments where the processing device 200 includes two or more processors, the processors can operate in a parallel or distributed manner. The processing device 200 can execute an operating system of the mobile device 3. In the illustrative embodiment, the processing device 200 also executes a shopping list generation logic 210 and a shopping-assistance logic 212, which are described in greater detail below.

The user interface 202 is a device that allows a user to interact with the mobile device 3. While one user interface 202 is shown, the term “user interface” may include, but is not limited to, a touch screen, a physical keyboard, a mouse, a microphone, and/or a speaker. The communication device 204 may be a device that allows the mobile device 3 to communicate with another device, e.g., the shopping list server 13, via the network 11. The communication device 204 may include one or more wireless transceivers for performing wireless communication and/or one or more communication ports for performing wired communication. The memory device 206 is a device that stores data generated or received by the mobile device 3. The memory device 206 may include, but is not limited to, a hard disc drive, an optical disc drive, and/or a flash memory drive.

The GPS 207 determines a location of the mobile device 3 by communicating with a plurality of GPS satellites. The GPS 207 can perform known triangulation techniques to determine the GPS coordinates of the mobile device 3. It should be appreciated that while a GPS 207 is shown, any other suitable component for determining the location of the mobile device 3 can be implemented.

The camera 208 may a digital camera that captures a digital photograph. The camera 208 receives an instruction to capture an image, captures an image of an object, i.e., a handwritten shopping list, and outputs the digital photograph. The digital photograph can be a bitmap file. The bitmap file can be a bitmap, a JPEG, a GIF, or any other suitably formatted file. The camera 208 can receive the instruction to capture the image from the processing device 200 and can output the digital photograph to the processing device 200.

The scanner 209 is a scanner that may scan quick reference (QR) codes, bar codes, product tags and any other tag of a product.

The shopping list generation logic 210 allows a user to generate an electronic-shopping list 10 and displays the electronic-shopping list 10 to the user in the GUI 7 (FIG. 1) via the user interface 202. As discussed previously the shopping list generation logic 210 may be configured to generate the electronic-shopping list 10 based on items manually entered by the user, a photograph of a handwritten shopping list, previous electronic-shopping lists of the user and/or a purchase history of the user. It is appreciated that the shopping list generation logic 210 can generate the electronic-shopping list 10 in any other suitable manner.

The shopping-assistance logic 212 assists the user when preparing to shop for the items in the electronic-shopping list 10. The shopping-assistance logic 212 can be configured to determine a store location indicating the store at which the user intends to purchase the products indicated in the electronic-shopping list 10. The store location may be represented in GPS coordinates of the store or by a store identifier, e.g., an alphanumeric string that identifies the store from other stores. In some embodiments, the shopping-assistance logic 212 uses the current location of the mobile device 3 to determine the store location. For instance, if a retailer operates three different stores in the vicinity of the mobile device 3, the shopping-assistance logic 212 can select the nearest store as the store location. The store locations can be obtained from a remote server, e.g., the shopping list server 13, and/or can be stored on the memory device 206 of the mobile device 3. In some embodiments, the shopping-assistance logic 212 allows the user to select the store location from a plurality of different store locations. For example, the shopping-assistance logic 212 may display a drop down menu in the GUI 7 that allows the user to select the store location. In these embodiments, the shopping-assistance logic 212 may instruct the user to provide a postal zip code and/or a city and state of the user. Using this information, the shopping-assistance logic 212 can display the N nearest store locations, where N is an integer greater than or equal to one. Alternatively, the shopping-assistance logic 212 can learn the user's preferred store location or can store the user's preferred store location. It should be appreciated that the shopping-assistance logic 212 may determine the store location in any other suitable manner.

In some embodiments, the shopping-assistance logic 212 determines the product waypoints for the items in the electronic-shopping list 10. In some of these embodiments, the shopping-assistance logic 212 provides the electronic-shopping list, or the items contained therein, and the store location to the shopping list server 13. The shopping list server 13 may return the product waypoints corresponding to the items contained in the electronic-shopping list 10 to the shopping-assistance logic 212. The shopping-assistance logic 212 can display the product waypoints to the user. In this way, the user may view the product waypoints when shopping to more efficiently locate the products indicated in the electronic-shopping list 10 when shopping.

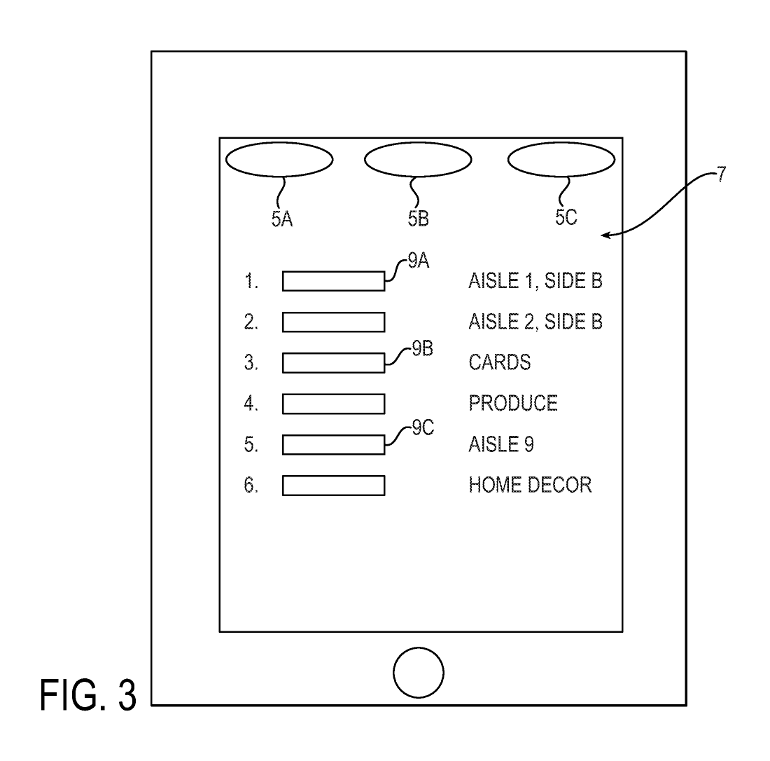

In some embodiments, each product waypoint may be displayed in the electronic-shopping list 10 relative to its corresponding item. For example, FIG. 3 illustrates an example of an electronic-shopping list 10 that has product waypoints displayed in relation to their corresponding items. In the illustrated example, the electronic-shopping list 10 is displayed on the left-hand side of the GUI 7. On the right-hand side, the product waypoints corresponding to each item are illustrated. As can be appreciated, the product waypoints can identify a specific aisle if the product indicated by the item is in an aisle. Otherwise, a description of the section of the product, e.g., “Produce” or “Sunglasses,” can be used to show the location of the product. It is noted that the example of FIG. 3 is provided for example only and not intended to be limiting.

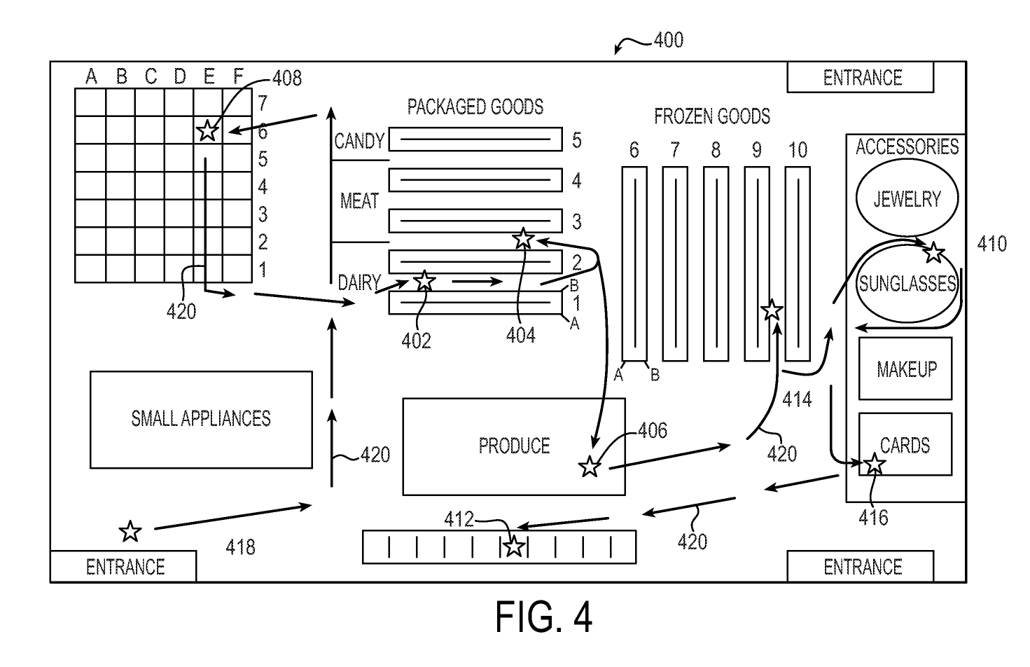

In some embodiments, the shopping list server 13 may also return a map corresponding to the store location. As used herein, the term “map” may refer to a digital representation of the layout of the corresponding store location. Referring to FIG. 4, an example of a map 400 having a plurality of product waypoints displayed therein is illustrated. The shopping-assistance logic 212 can display the map 400 to the user via the user interface 202 (FIG. 2). In the illustrated example, the product waypoints are displayed as graphical icons, e.g., stars. For example, the map 400 includes a first product waypoint 402 (e.g., location of “milk”) and a second product waypoint 404 (e.g., location of “cheese”) in the dairy section. Additionally, the map 400 includes a third product waypoint 406 (e.g., location of “lettuce”) in the produce section, a fourth product waypoint 408 (e.g., location of “curtains”) in the home decor department, a fifth product waypoint 410 (e.g., location of “sunglasses”) in the kids clothing department, and an sixth product waypoint 416 (e.g., location of “HALLMARK™ card”) in the cards/stationary department. Furthermore, the map 400 includes a seventh waypoint 414 (e.g., location of “ice cream”) in the frozen goods section. As can be appreciated, the graphical icon used to represent the seventh waypoint 414 is a bold line, thereby indicating that the entire sides of aisle 9 contains ice cream.

In some embodiments, the graphical icons representing the product waypoints can be displayed in the map 400 in varying sizes to indicate to the user the relative amount of space that is occupied by the product indicated in the electronic-shopping list 10. For example, the product referenced by the first product waypoint 402 may represent the location of “cheese” while the product referenced by the second product waypoint 404 represent the location of “milk.” As can be appreciated by the respective sizes of the first product waypoint 402 and the second product waypoint 404 in this example, the amount of space occupied by milk is greater than the amount of space occupied by cheese.

Furthermore, in some embodiments, the map 400 may also display an entrance waypoint 418 and/or a checkout waypoint. The entrance waypoint 418 may indicate a suggested entrance for the user to enter/exit from. The checkout waypoint 412 may indicate one or more suggested checkout lanes at which the user can check out.

It is noted that in some embodiments, the shopping-assistance logic 212 can be configured to receive the map 400 and the various waypoints 402-418, and to render the map 400 with the waypoints 402-418 displayed therein. In other embodiments, the shopping list server 13 may be configured to render the various waypoints 402-418 in the map 400 and to provide the rendered map 400 to the shopping-assistance logic 212.

In some embodiments, the shopping-assistance logic 212 can utilize the current location of the user to display the current location of the user in the map 400 while the user is shopping. In this way, the user can reference his or her location in relation to the various waypoints 402-418 to better navigate through the store. It is noted that the example map 400 of FIG. 4 is provided for example and not intended to be limiting.

Referring back to FIG. 2, in some embodiments the shopping-assistance logic 212 is configured to determine an optimized route for the shopper to travel when shopping for the products indicated in the electronic-shopping list 10. In some of these embodiments, the shopping-assistance logic 212 provides the electronic-shopping list, or the items contained therein, and the store location to the shopping list server 13. The shopping list server 13 can return a route corresponding to the items contained in the electronic-shopping list 10 to the shopping-assistance logic 212. In some embodiments, the route can be optimized, for example, to minimize a distance traveled through the store or to minimize an amount of time spent traveling through the store. The shopping list server 13 may further return the product waypoints corresponding to the items contained in the electronic-shopping list 10.

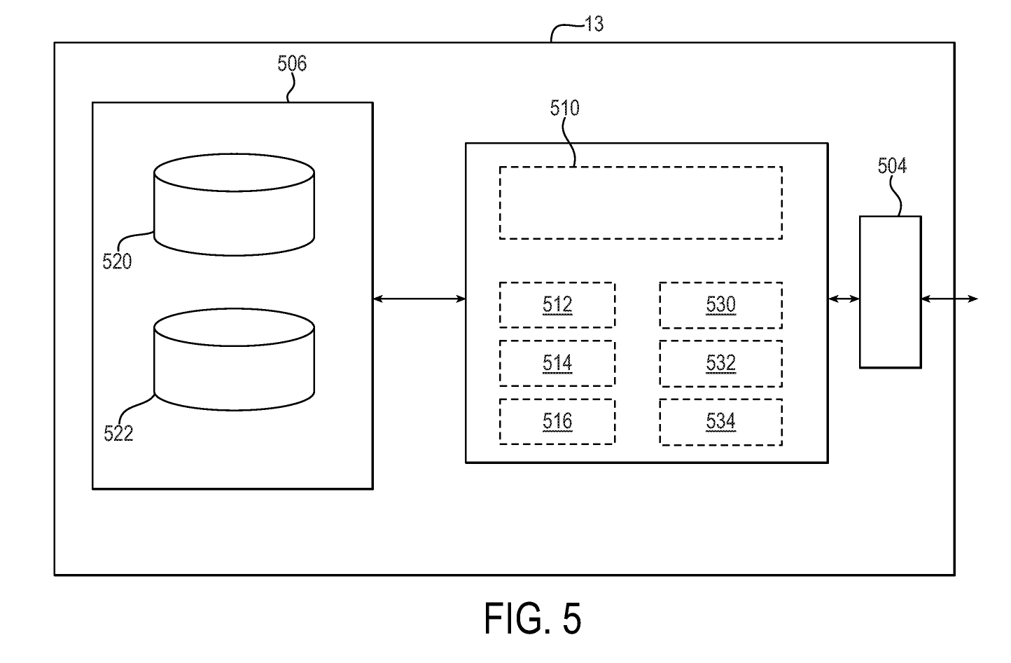

In some embodiments, the shopping-assistance logic 212 can display the route to the user in a map. FIG. 5 illustrates an example of a map 400 having a route 420 displayed therein. The example map 400 of FIG. 4 additionally illustrates an example route 420 that begins at the entrance waypoint 418 and travels through the fourth waypoint 408, then the first waypoint 402, the second waypoint 404, the third waypoint 406, the seventh waypoint 414, the fifth waypoint 410, the sixth waypoint 416, and the cashier waypoint 412.

It is noted that in some embodiments, the shopping-assistance logic 212 can be configured to receive the map 400, the various waypoints 402-418, and the route 420 and to render the route 420 and the waypoints 402-418. In other embodiments, the shopping list server 13 may be configured to render the route 420 and the various waypoints 402-418 in the map 400 and to provide the rendered map 400 to the shopping-assistance logic 212. In some embodiments, the shopping-assistance logic 212 can utilize the current location of the user to display the current location of the user in the map 400 while the user is shopping. In this way, the user can reference his or her location in relation to the route 420 to better navigate through the store. It is noted that the example map 400 of FIG. 5 is provided for example and not intended to be limiting.

Referring back to FIG. 2, in some embodiments the shopping-assistance logic 212 is configured to rearrange and/or group the items in the electronic-shopping list, such that the items are rearranged or grouped in a manner to increase the efficiency of the user's shopping experience. For example, in some embodiments the items can be rearranged according to the respective locations of the products indicated by the items. In these embodiments, the items can be rearranged such that the items are displayed in an order that corresponds to the respective distance between other items. For example, in the electronic-shopping list 10 of FIG. 1, “curtains” are listed after “HALLMARK™ card”. Assuming that curtains are in the home decor department and HALLMARK∩ cards are located in the stationary department, the items may be rearranged in the electronic-shopping list 10 such that the “HALLMARK™ card” is displayed directly before or after sunglasses, while “curtains” is displayed after lettuce and before ice cream.

In other embodiments, the items can be grouped according to the types of the products indicated in the electronic-shopping list 10 and/or the respective sections/departments of the products indicated in the electronic-shopping list 10. In one example of an ordered shopping, the electronic-shopping list 10 of FIG. 1 may be rearranged and grouped according to product type. For example, the ordered electronic-shopping list 10 includes a “groceries” grouping, a home decor grouping, and a personal items grouping. Furthermore, within the groupings, the ordered electronic-shopping list 10 may be grouped according to section/department. For example, the “cheese” item and the “milk” item have been grouped in a “dairy” grouping. As can be appreciated, the “dairy” grouping is indicative of the section of the store where cheese and milk can be found. This example is provided for illustrative purposes and not intended to be limiting. The items appearing in the ordered shopping list can be grouped according to any other suitable categories.

As referenced above, in some embodiments the shopping list server 13 may be configured to perform one or more functions at the request of the mobile device 3. FIG. 5 illustrates an example embodiment of the shopping list server 13 configured to perform one or more requested function(s). In the illustrated embodiment, the shopping list server 13 may include a processor 500, a communication device 504, and memory device 506. The processor 500 may include memory, e.g., read only memory (ROM) and random access memory (RAM), storing processor-executable instructions and one or more processors that execute the processor-executable instructions. In embodiments where the processor 500 includes two or more processors, the processors can operate in a parallel or distributed manner. In the illustrative embodiment, the processor 500 executes one or more of a store locator logic 510, a product locator logic 512, a route determination logic 514, and a grouping logic 516.

The communication device 504 is a device that allows the shopping list server 13 to communicate with another device, e.g., the mobile device 3, via the network 11. The communication device 504 may include one or more wireless transceivers for performing wireless communication and/or one or more communication ports for performing wired communication.

The memory device 506 is a device that stores data generated or received by the shopping list server 13. The memory device 506 may include, but is not limited to a hard disc drive, an optical disc drive, and/or a flash memory drive. Further, the memory device 506 may be distributed and located at multiple locations. The memory device 506 is accessible to the processor 500. In some embodiments, the memory device 506 stores a store location database 520 and a product location database 522.

In some embodiments, the store location database 520 can store the store locations of one or more stores operated or associated with a retailer. The store location database 520 may be queried using a specific location, e.g., GPS coordinates, or a general location, e.g., postal zip code or city/state, and can return one or more stores that are proximate to the specific or general location. The store location database 520 may further be configured to store maps corresponding to each store location. The store location database 520 may be queried with a store location and can return the store map corresponding to the store location.

In some embodiments, the product location database 522 stores product waypoints indicating locations of the products sold by a retailer in the one or more stores operated or associated with the retailer. For example, the product location database 522 may store the location of “milk” in each of the stores operated or associated with the retailer. The product location database 522 may be queried with the item “milk” and a specific store location, and may return a waypoint indicating the location of “milk” at the specific store location.

The product location database 522 may be configured to store waypoints for specific products and generic products. For example, the product location database 522 may be configured to store waypoints indicating the location of “ice cream,” a generic product, and the location of “BEN AND JERRY'™ ice cream,” a specific product. It should be noted that a waypoint corresponding to a generic product or specific product may be represented using a starting location and ending location. For example, a waypoint corresponding to “ice cream” may indicate where the ice cream section begins and where the “ice cream” section ends. Similarly, a waypoint corresponding to “BEN AND JERRY'S™ ice cream” may indicate where the BEN AND JERRY'S™ ice cream begins and ends. It should be appreciated that when a specific product is a species of a generic product, e.g., BEN AND JERRY'S™ ice cream is a species of “ice cream,” the waypoint corresponding to a specific product may be wholly contained within the waypoint corresponding to the generic product. In some embodiments, a generic product may be located in more than one location in the store. For example, milk may be located in the dairy section, while organic milk may be located in the natural foods location. In this type of scenario, the product location database 522 may store more than one location for milk. When such a situation arises, the product locator logic 512 may retrieve multiple product waypoints, such that the multiple waypoints corresponding to the generic product are provided to the mobile device 3.

The product location database 522 may further store a type of each product sold by the retailer, e.g., groceries, home decor, and personal goods, and/or a section of the product, e.g., dairy or men's clothing. Furthermore, the types and/or sections can be stored relative to each store location. In this way, the product location database 522 can be queried with a store location and a product and can return a type of the product and/or a section of the product at the store location.

As discussed, the processor 500 may execute the store locator logic 510. The store locator logic 510 receives a location from the mobile device 3 and determines one or more store locations corresponding to the received location. In some embodiments, the store locator logic 510 queries the store location database 520 with the received location and receives one or more store locations that correspond to the received location. For example, the store location database 520 may return any store locations that are within a predetermined distance, e.g., 10 miles, from the received location. When more than one store location is received, the store locator logic 510 may automatically select the store location nearest to the received location or may provide the store locations to the mobile device 3, thereby allowing the mobile device 3 or the user to select the store location.

The product locator logic 512 receives an electronic-shopping list 10 containing one or more items and determines product waypoints corresponding to the one or more items. In some embodiments, the product locator logic 512, for each item in the electronic-shopping list, queries the product location database 522 with the item and a store location (which may have been determined by the store locator logic 510) and receives a product waypoint indicating a location of the product indicated by the item in the store corresponding to the store location. Furthermore, the product locator logic 512 can be configured to determine an entrance waypoint and/or a checkout waypoint based on the items contained in the electronic-shopping list 10.

Once the product locator logic 512 has determined the various waypoints, e.g., product waypoints, checkout waypoint, and entrance waypoint, the product locator logic 512 may provide the product waypoints to the mobile device 3, such that the mobile device 3 may display the product waypoints in the electronic-shopping list 10.

In some embodiments, the product locator logic 512 may be further configured to obtain a map corresponding to the store location. The product locator logic 512 can obtain the map from the store location database 520. In some of these embodiments, the product locator logic 512 can provide the map and the product waypoints to the mobile device 3. Alternatively, the product locator logic 512 can render the map with the various waypoints displayed therein. In these embodiments, the product locator logic 512 may use the locations indicated by the various waypoints to determine locations in the map where the graphical icons should be displayed. The product locator logic 512 can then insert the graphical icons at the determined locations. The product locator logic 512 can provide the rendered image to the mobile device 3.

Referring back to FIG. 5, the route determination logic 514 determines a route to recommend to a user when shopping for the products indicated in the electronic-shopping list 10. The route determination logic 514 receives the electronic-shopping list 10, or the items contained therein, and determines a route based on the items contained in the electronic-shopping list 10. In some embodiments, the route determination logic 514 is configured to optimize the route to minimize the amount of distance traveled and/or the amount of time spent traveling through the store.

In operation, the route determination logic 514 can determine a store location of the user. Based on the store location, the route determination logic 514 can obtain a map corresponding to the store location. The route determination logic 514 can determine the product waypoints corresponding to the products indicated by the items in the electronic-shopping list 10 based on the items and the store location.

After the various waypoints have been determined, the route determination logic 514 can determine the route based on the waypoints. Once the optimized route is determined, the route determination logic 514 can provide the map, the various waypoints, and the route to the mobile device 3. As discussed with respect to the product locator logic 512, the route determination logic 514 can render and provide an image of the map with the various waypoints and the route displayed therein, or can provide the map, the product waypoints, and the route individually to the mobile device 3.

Referring back to FIG. 5, the grouping logic 516 rearranges and groups the items in the electronic-shopping list 10 such that the items are grouped according to the type of the products indicated by the items. In some embodiments, the grouping logic 516 receives the electronic-shopping list, or the items contained therein. For each item, the grouping logic 516 determines a type of the item. In some embodiments, the term “type” refers to a high-level genus of the product indicated by the item. Examples of types of items include grocery items, clothing items, accessory items, personal items, and hardware items. Each item may then be assigned to a grouping based on its type. It is noted that the groupings represent the different types, e.g., a grocery grouping, clothing grouping, and hardware grouping. Once the items have been assigned to the groupings, the groupings may then be provided to the mobile device 3. In this way, the electronic-shopping list 10 has been ordered based on groupings.

In some embodiments, the grouping logic 516 can be further be configured to determine a section of each item. As discussed above, a section of the item can indicate the area of the store where the item is stocked, e.g., dairy section, frozen goods section. In these embodiments, the grouping logic 516 can, for each of the groupings, assign the items in the grouping to their respective section such that items that are found in the same section are grouped in the same section. Once the items have been assigned to their respective sections, the groupings and sections can be provided to the mobile device 3. In this way, the electronic-shopping list 10 has been ordered based on groupings and sections.

In some embodiments, the grouping logic 516 can be configured to reorder the electronic-shopping list 10 based on the locations of the products indicated in the electronic-shopping list 10. In these embodiments, the grouping logic 516 can request that an optimized route from the route determination logic 514. The grouping logic 516 can then reorder the items in the electronic-shopping list 10 to match the order of the waypoints in the optimized route.

In some embodiments, the server 13 may also contain one or more of: upsell logic 530, warning logic 532 and, checkout logic 534. As mentioned above and in more detail later, the upsell logic 530 assists a retailer in upselling a customer by detecting what the customer has scanned for possible purchase and providing information about other related products on the customer's mobile device. The warning logic 532 may assist a retailer in warning a customer by causing a warning message to be displayed on the mobile device 3 indicating that they have scanned an item that contains an ingredient that the customer is allergic to consuming or otherwise does not desire to purchase. The checkout logic 534 provides for a rapid way to pay for items the customer has scanned for purchase, as discussed below.

In some embodiments, Diebold Nixdorf's Extreme automatic transaction machine (ATM) concept may be used with the mobile device to withdraw cash from an ATM. The Extreme ATM measure just under 10 inches (25 centimeters) wide. The Extreme ATM unlike traditional (ATM) designs and fits well in environments wherein space is at a premium.

In one embodiment, a user may use integrated Bluetooth proximity technology with their Bluetooth-enabled mobile device to authenticate themselves and then tap their mobile device at the ATM and complete their transaction.

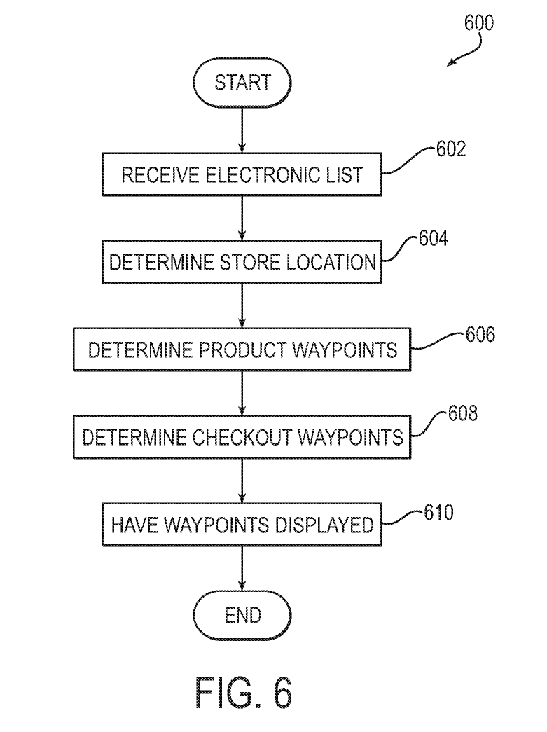

The method 600 of FIG. 6 is provided for example and not intended to be limiting. The example methods may be better appreciated with reference to flow diagrams. For purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not-illustrated blocks. Thus, the depicted blocks, functions and/or other components may be implemented as parts of a monolithic software structure, as standalone software modules, or as modules that employ external routines, code, services, and so forth, or any combination of these. All such implementations are within the scope of the present disclosure.

It should be appreciated that the method 600 may include additional operations and some operations may be varied without departing from the scope of the disclosure. As previously stated, the method 600 can be modified such that it may be executed by the processor 200 of the mobile device 3. For example, the method 600 may be executed by the shopping-assistance logic 212.

At operation 602, the product locator logic 512 receives the electronic list 10 (or the items contained therein) from the mobile device 3. At operation 604, the product locator logic 512 determines a store location. In some embodiments, the mobile device 3 may provide the store location. In other embodiments, the mobile device 3 may provide its current location, and the product locator logic 512 may obtain the store location from the store locator logic 510.

At operation 606, the product locator logic 512 determines one or more product waypoints respectively corresponding to the one or more items contained in the electronic-shopping list. For each item, the product locator logic 512 can query the product location database 522 with the item and the store location. As discussed, the product location database 522 returns a product waypoint indicating the location of the product indicated by the item in the store corresponding to the store location.

At operation 608, the product locator logic 512 determines a checkout waypoint and an optional entrance waypoint. In some embodiments, the product locator logic 512 can determine the checkout waypoint based on the number of items in the electronic-shopping list and/or the determined product waypoints. For example, in some embodiments the product locator logic 512 sets the checkout waypoint equal to the locations of the “express checkout” aisles when the number of items in the electronic-shopping list is less than a predetermined threshold, e.g., 15 items. Otherwise, the product locator logic 512 can set the checkout waypoint equal to the location of the aisles closest to the last item on the electronic-shopping list. In some embodiments, the product locator logic 512 can determine the entrance waypoint based on the determined checkout waypoint, e.g., the entrance nearest to the checkout waypoint. Alternatively, the entrance waypoint can be determined based on the product waypoints. For instance, if all of the products (or a majority of products) are located on the west side of the store, the entrance waypoint may be set equal to the location of the west side of the store.

At operation 610, the product locator logic 512 provides the various waypoints for display at the mobile device 3 (e.g., mobile computing device). As discussed above, the product locator logic 512 can provide the various waypoints to the mobile device 3. In some embodiments, the product locator logic 512 can also provide a map corresponding to the store location to the mobile device 3, such that the mobile device 3 can render the map with the various waypoints displayed therein. In other embodiments, the store locator logic 510 can render an image of the map with the various waypoints displayed therein, whereby the image is provided to the mobile device 3.

The method 600 of FIG. 6 is provided for example and not intended to be limiting. It should be appreciated that the method 600 may include additional operations and some operations may be varied without departing from the scope of the disclosure. As previously stated, the method 600 can be modified such that it may be executed by the processing device 100 of the mobile device 3. For example, at least some portions of the method 600 may be executed by the shopping-assistance logic 212.

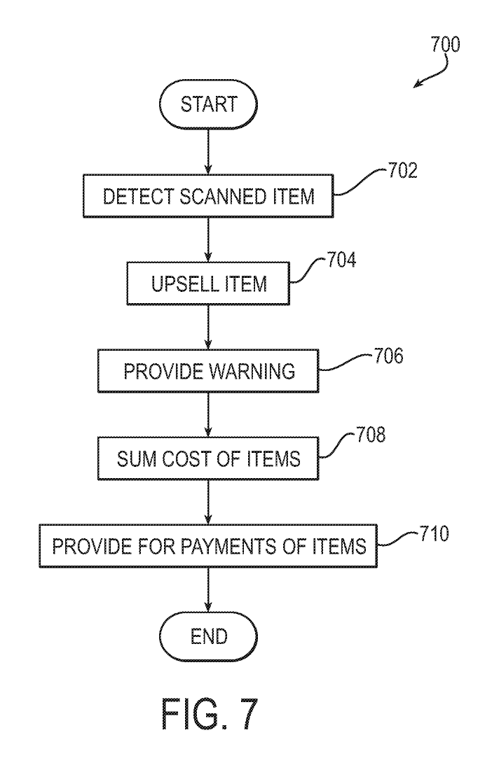

As previously mentioned, the retailer may have ability to interface with the user's electronic list 10 or to monitor what the user is scanning into their cart/basket so that the retailer may upsell the user. FIG. 7 illustrates and example method 700 of upselling and/or providing a warning for a scanned item. For example, the method 700 may begin by the upsell logic 530 in the retailer's server 13 detecting an item such as a toy has been scanned, at 702. The retailer's server 13 may then upsell the scanned item, at 704. For example, the server 13 may send a message to the user and/or the user's electronic list 10 to inform the user that the toy that was scanned will need batteries and possibly ask whether batteries should be added to the electronic list. The user can then request the batteries be added to the electronic list 10, or not.

In alternate configurations, the warning logic 532 of the server 13 of the retailer's computer system may provide warnings to a customer. For example, the mobile device 3 may be preloaded with substances a user or their family is allergic to, such as dairy products. This information is shared with the server 13. Later when a customer scans an item containing a dairy product or another item that they are allergic to, the warning logic 532 may provide a warning, at 706, to the user through the mobile device 3 to give the customer the options of not purchasing that item. It must be appreciated that many other scenarios where the user may want to be warned when certain products are scanned.

Because everything has been pre-scanned as it is placed in the user's cart, basket or the like, payment when the user's shopping is complete may be greatly simplified without requiring the retailer's associates overseeing the checkout process or having minimum associate involvement in the payment process. In one embodiment, the mobile device 3 and/or the checkout logic 534 may sum, at 708, all the items that were scanned as they are scanned or when a user signals he/she is finished shopping. A user may have earlier upload his credit card account information or other banking account information and onto their mobile device 3 and/or a banking computer system to create “mobile wallet”. At a checkout terminal or a point of sale (POS) the user may select a payment method by interacting with their mobile device 3. The user/customer may then bring the mobile device in into a near field communication (NFC) wireless signal and, with the assistance of the checkout logic 534 in the retailer's server 13, authorize payment, at 710, using the selected credit card or other bank account. In other embodiments, the user may tap their mobile device 3 on an Irving ATM or a similar type of POS or checkout device to complete the payment to the retail establishment. It must be appreciated that other ways to process a payment after items/products have been previously scanned is possible.

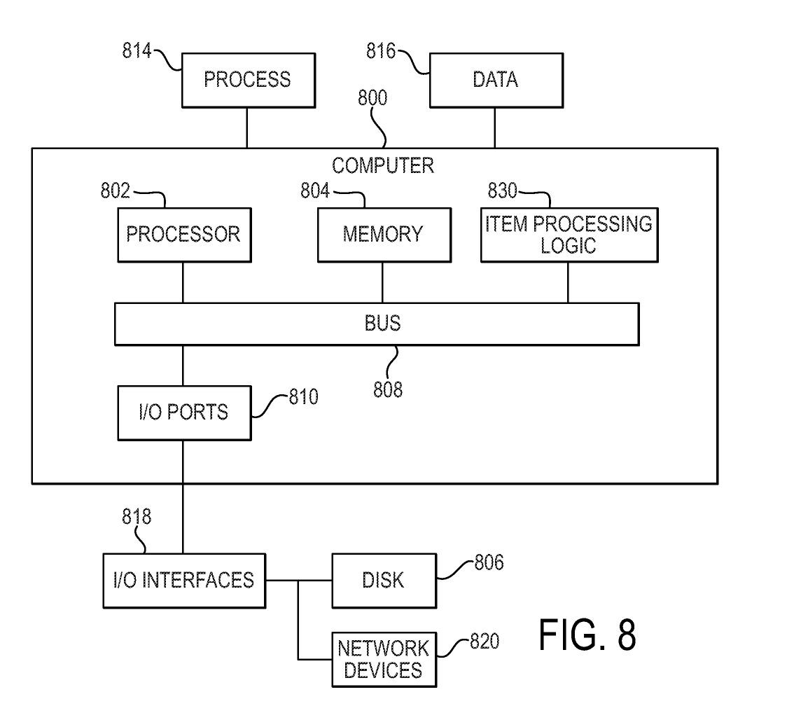

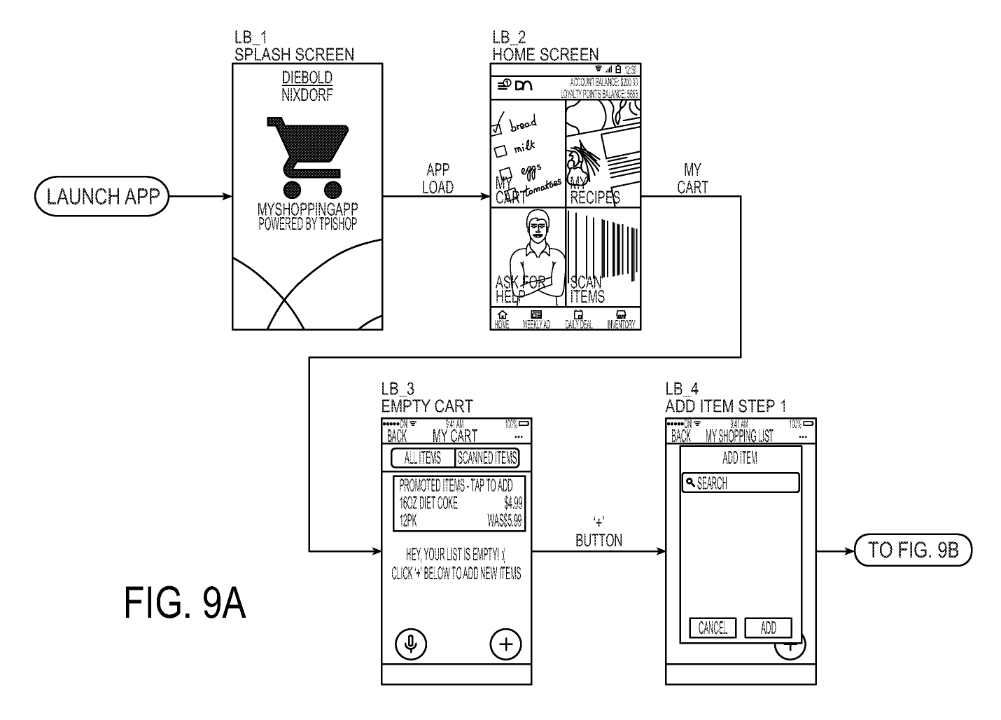

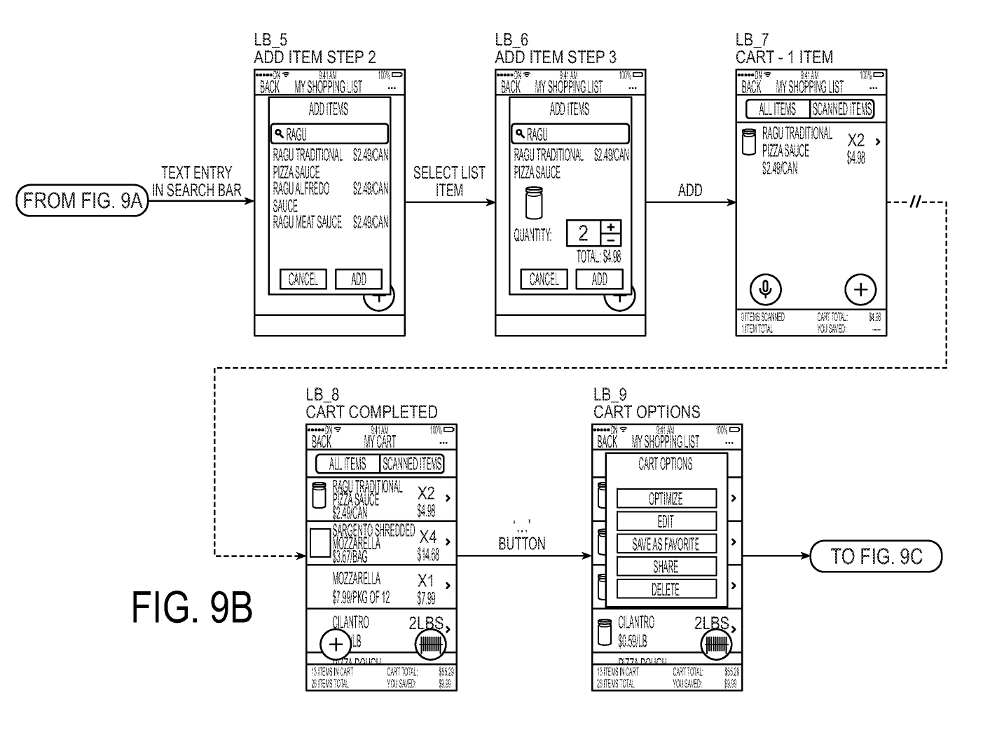

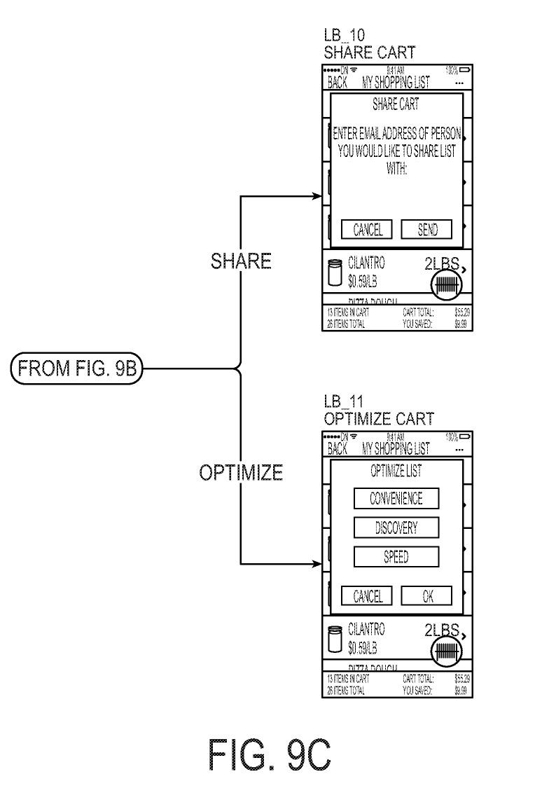

FIG. 8 illustrates an example computing device in which example systems and methods described herein, and equivalents, may operate. The example computing device may be a computer 800 that includes a processor 802, a memory 804, and input/output ports 810 operably connected by a bus 808. In one example, the computer 800 may include an item processing logic 830 that may assist in upselling an item, and/or paying for items as discussed above. In different examples, the item processing logic 830 may be implemented in hardware, software, firmware, and/or combinations thereof. While the item processing logic 830 is illustrated as a hardware component attached to the bus 808, it is to be appreciated that in one example, the item processing logic 830 could be implemented in the processor 802.

Generally describing an example configuration of the computer 800, the processor 802 may be a variety of various processors including dual microprocessor and other multi-processor architectures. The memory 804 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), direct RAM bus RAM (DRRAM) and the like.

A disk 806 may be operably connected to the computer 800 via, for example, an input/output interface (e.g., card, device) 818 and an input/output port 810. The disk 806 may be, for example, a magnetic disk drive, a solid-state disk drive, a floppy disk drive, a tape drive, a Zip drive, a flash memory card, and/or a memory stick. Furthermore, disk 806 may be a CD-ROM, a CD recordable drive (CD-R drive), a CD rewriteable drive (CD-RW drive), and/or a digital video ROM drive (DVD ROM). The memory 804 can store a process 814 and/or a data 816, for example. The disk 806 and/or memory 804 can store an operating system that controls and allocates resources of the computer 800.

The bus 808 may be a single internal bus interconnect architecture and/or other bus or mesh architectures. While a single bus is illustrated, it is to be appreciated that the computer 800 may communicate with various devices, logics, and peripherals using other busses (e.g., PCIE, SATA, Infiniband, 1384, USB, Ethernet). The bus 808 can be types including, for example, a memory bus, a memory controller, a peripheral bus, an external bus, a crossbar switch, and/or a local bus.

The computer 800 may interact with input/output devices via the input/output interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, USB ports, and the like.

The computer 800 can operate in a network environment and thus may be connected to the network devices 820 via the input/output interfaces 818, and/or the input/output ports 810. Through the network devices 820, the computer 800 may interact with a network. Through the network, the computer 800 may be logically connected to remote computers. Networks with which the computer 800 may interact include, but are not limited to, a local area network (LAN), a wide area network (WAN), and other networks. The networks may be wired and/or wireless networks.

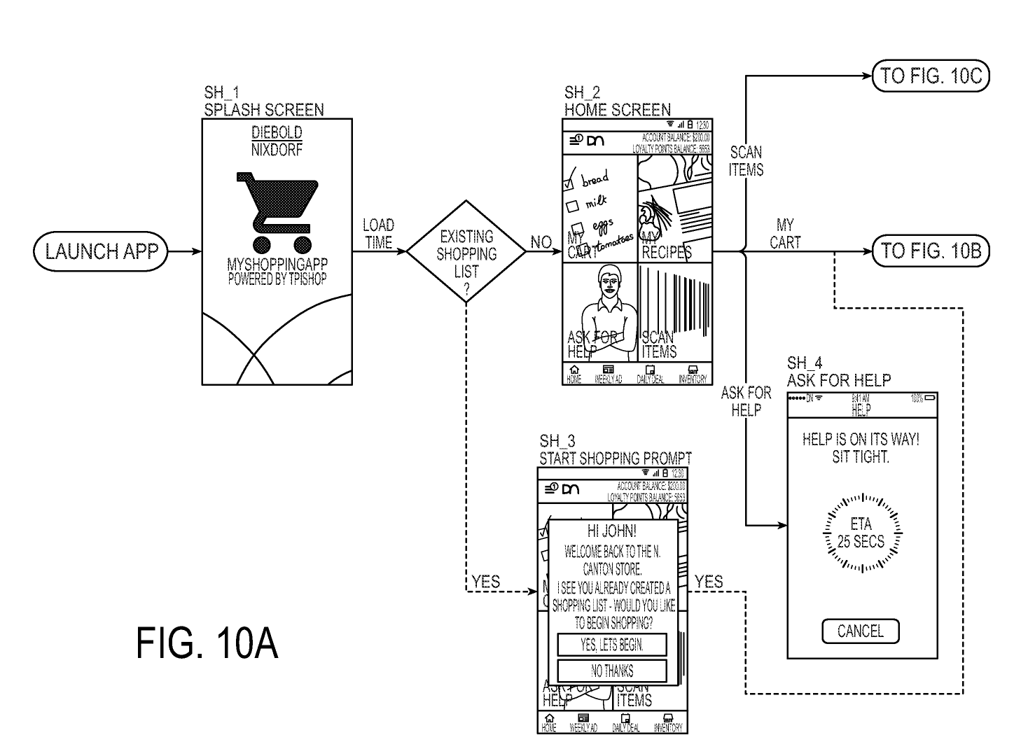

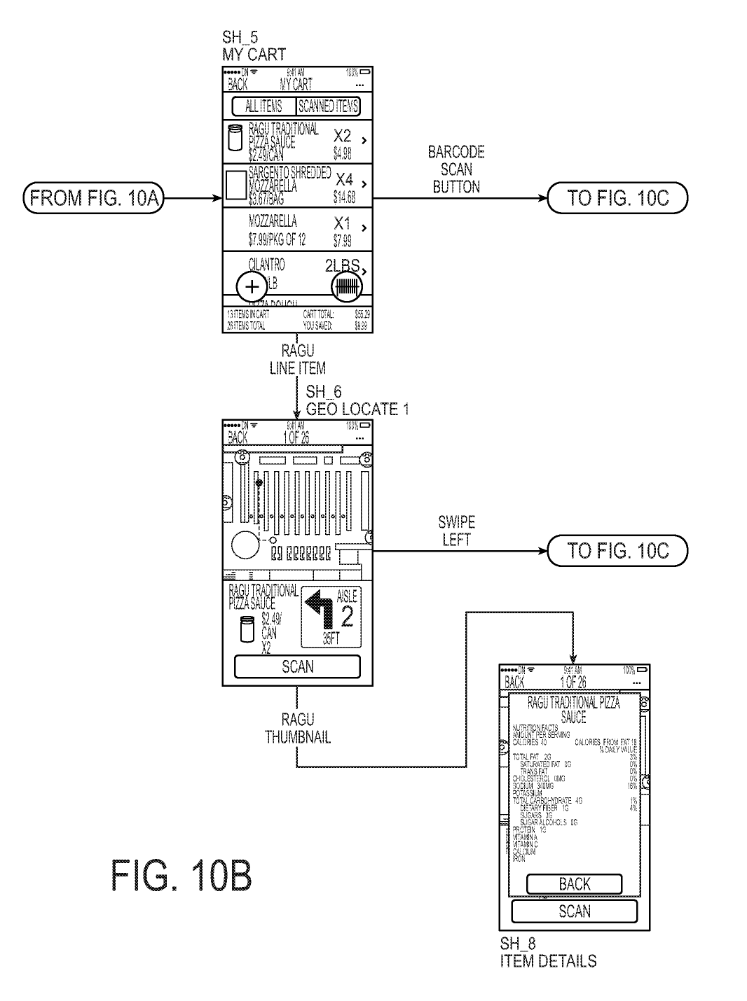

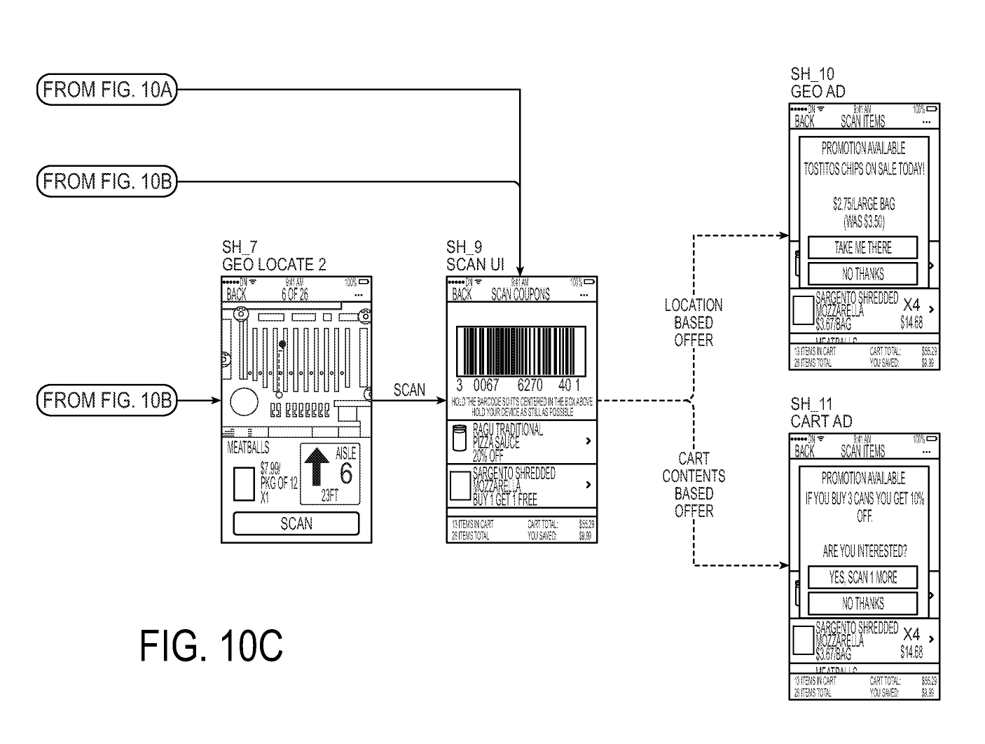

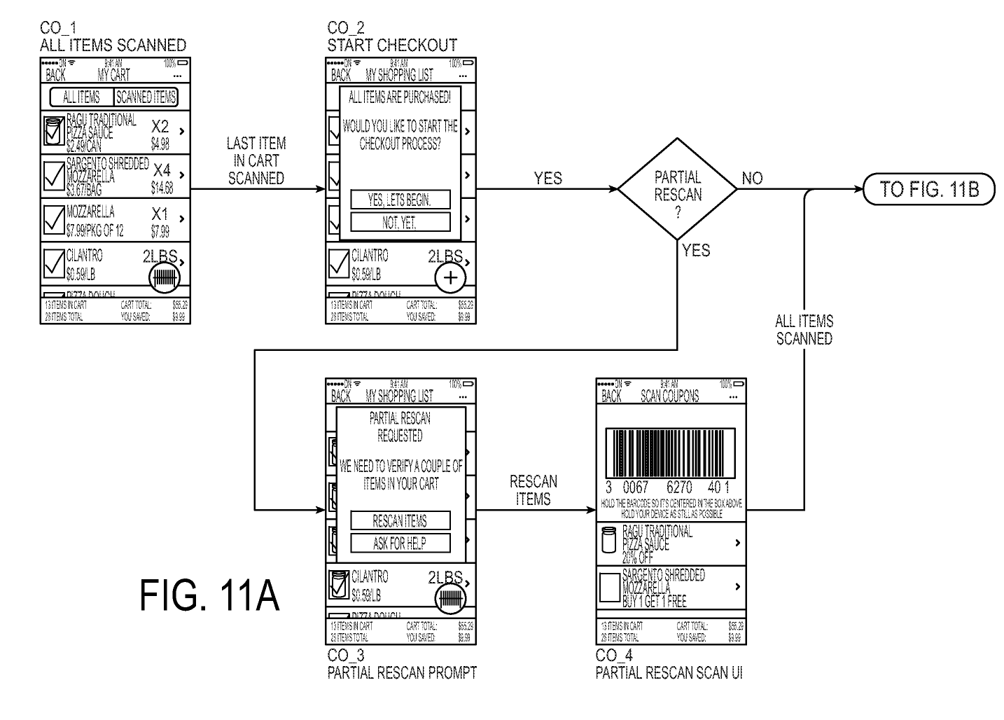

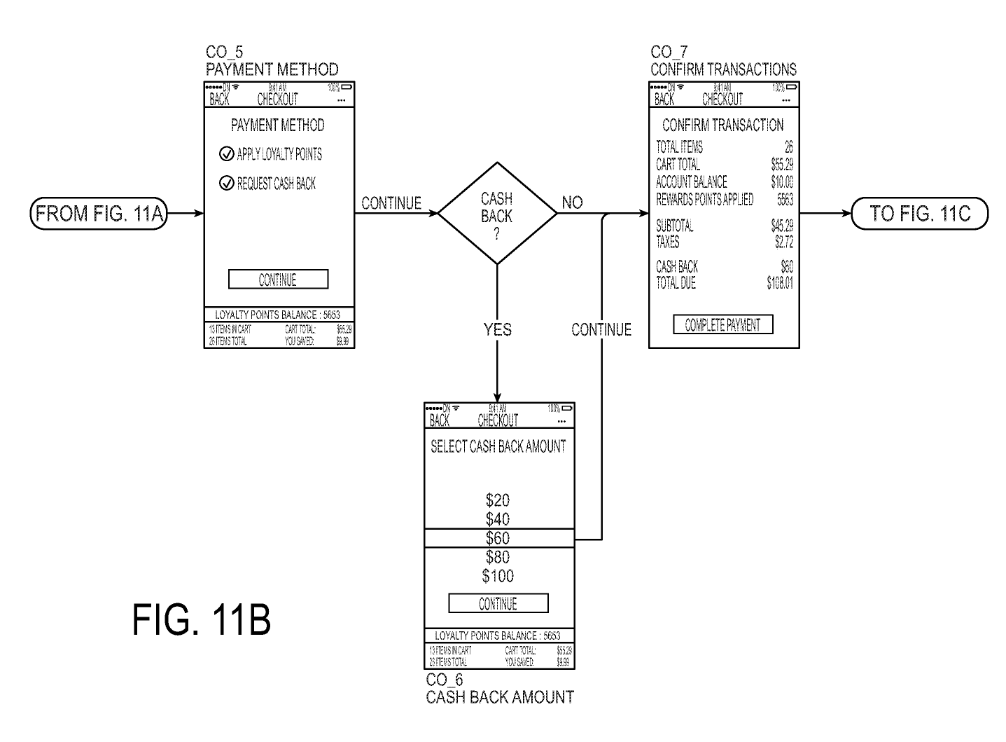

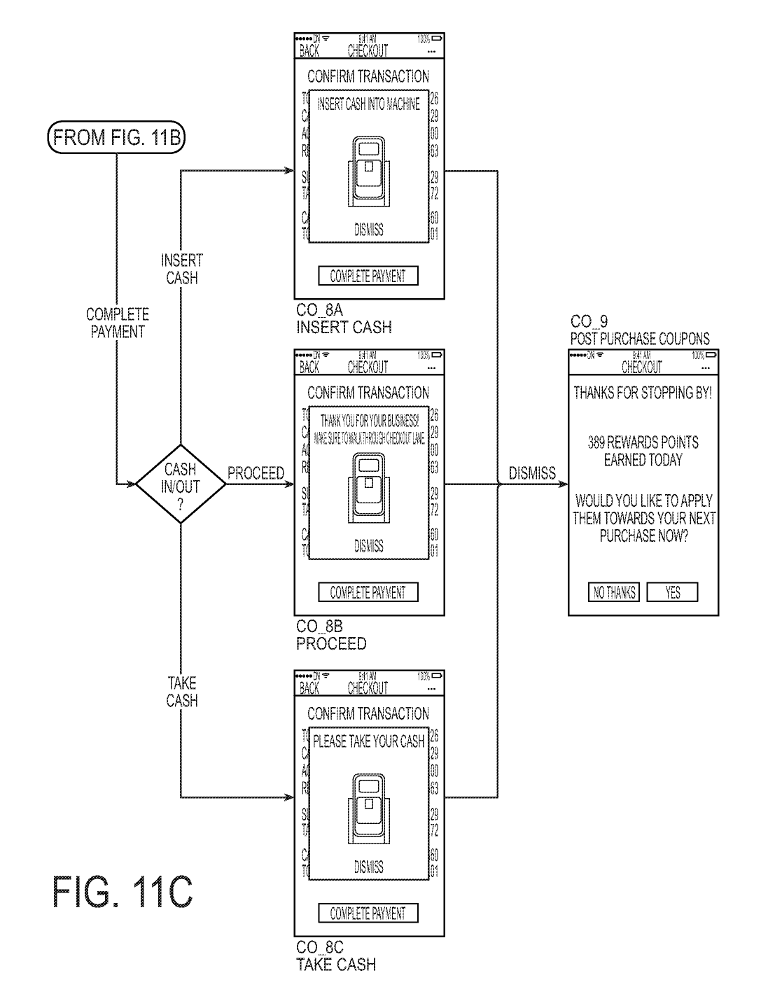

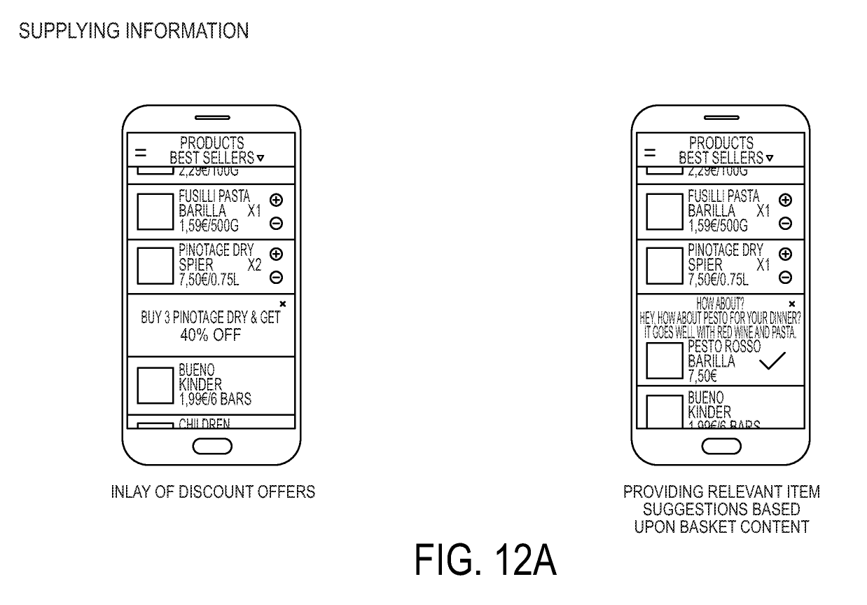

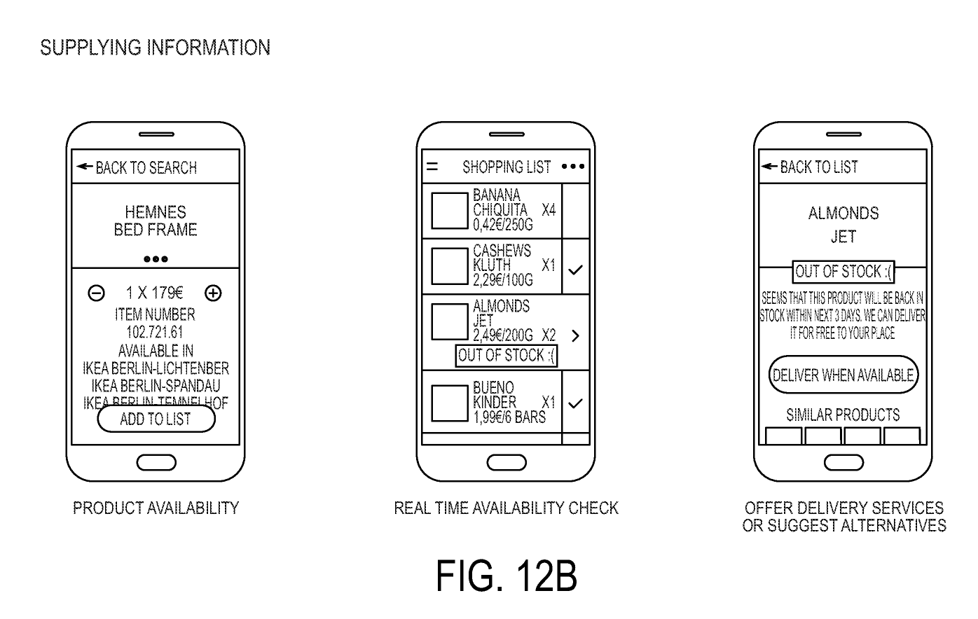

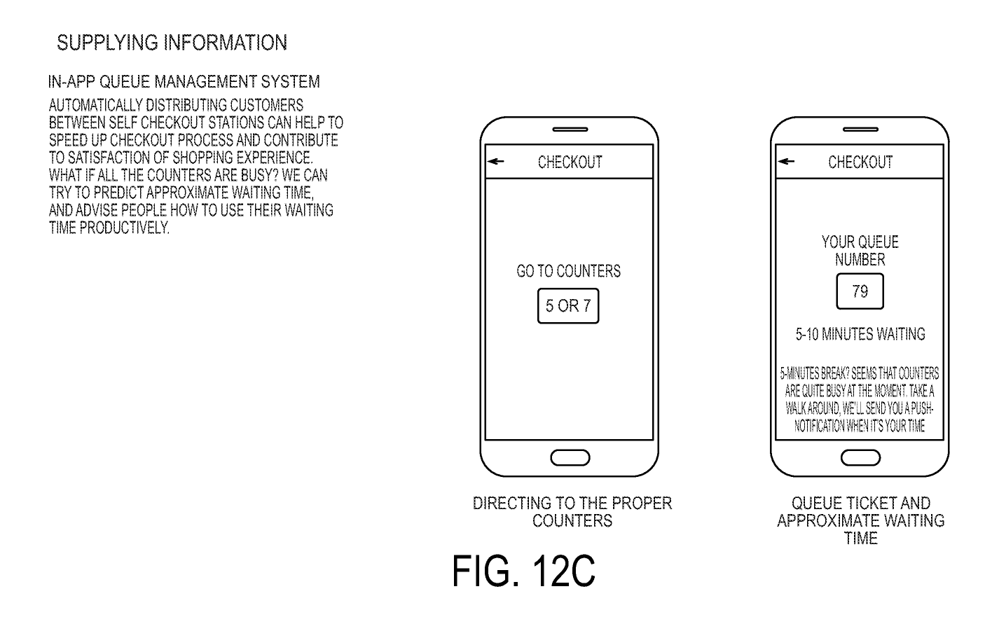

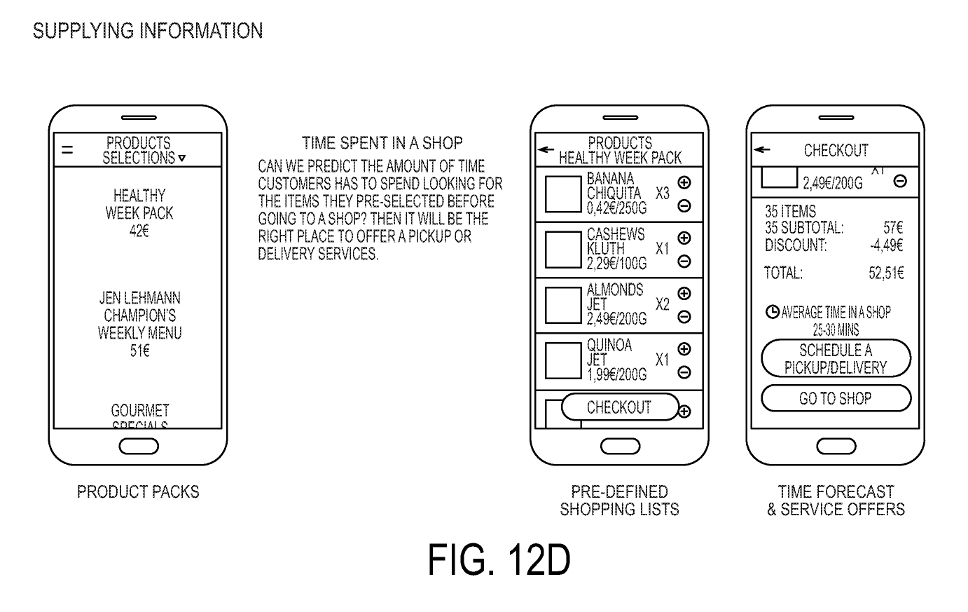

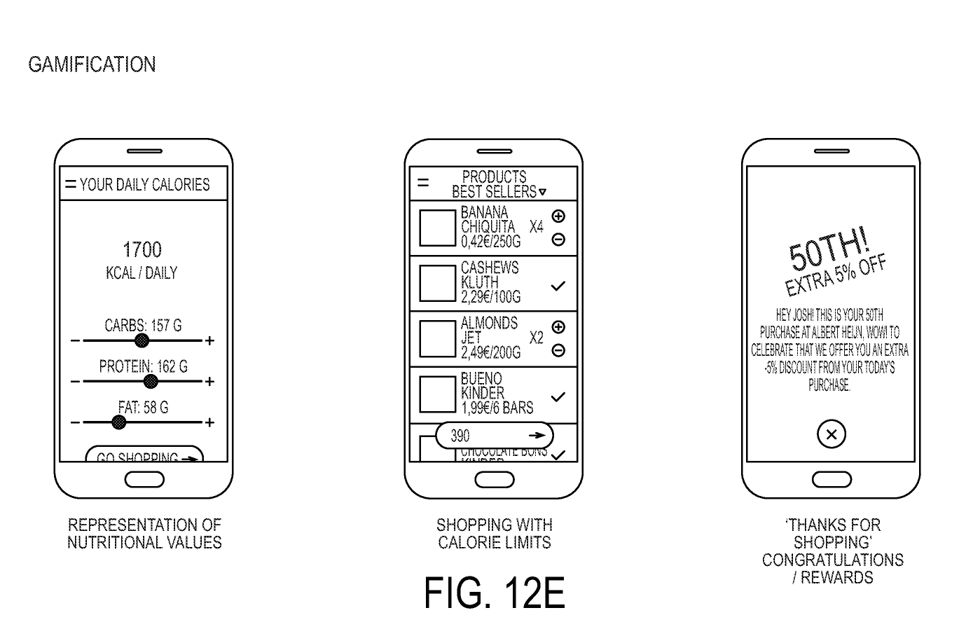

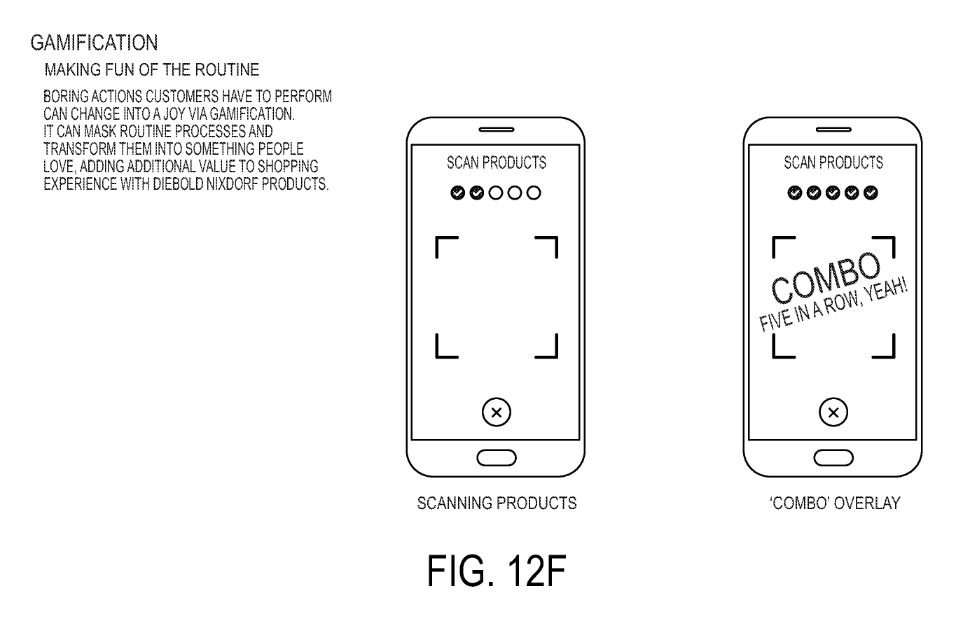

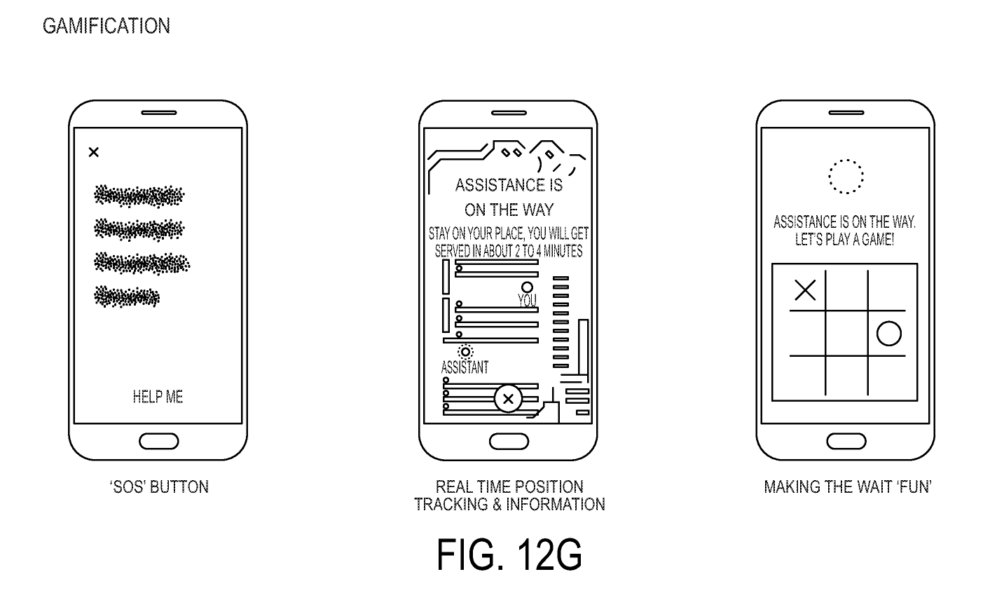

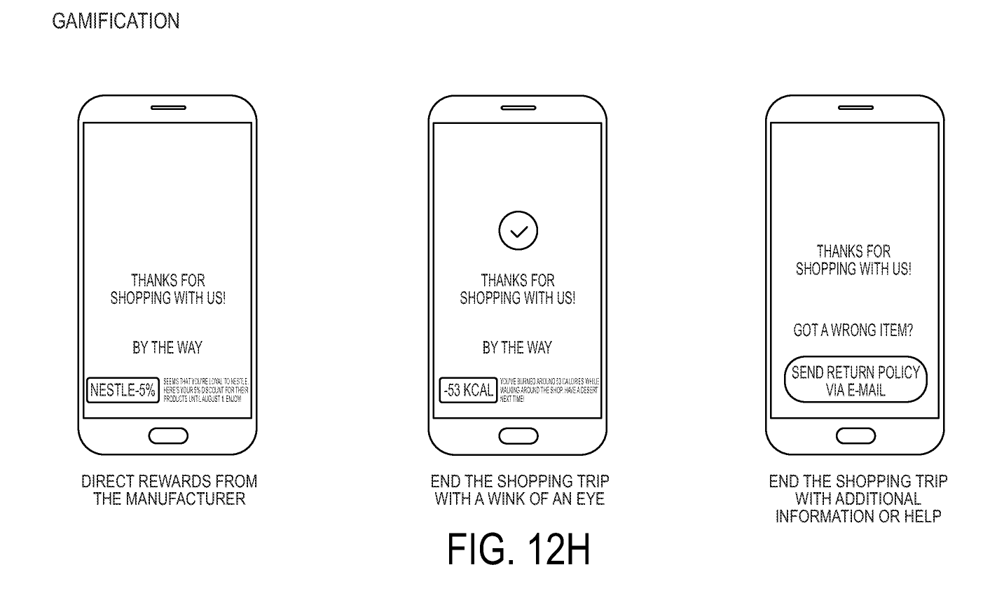

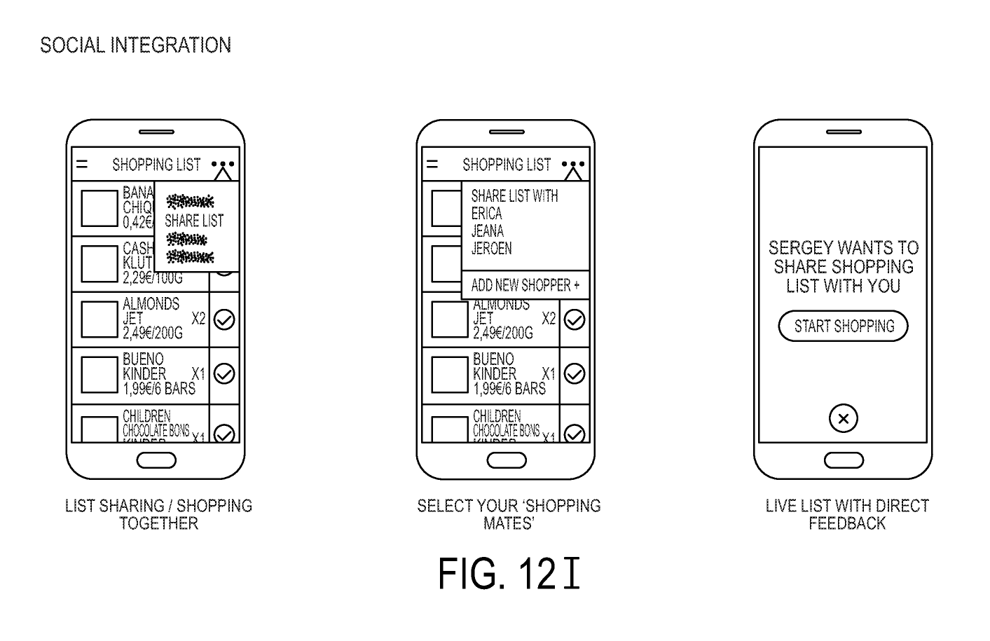

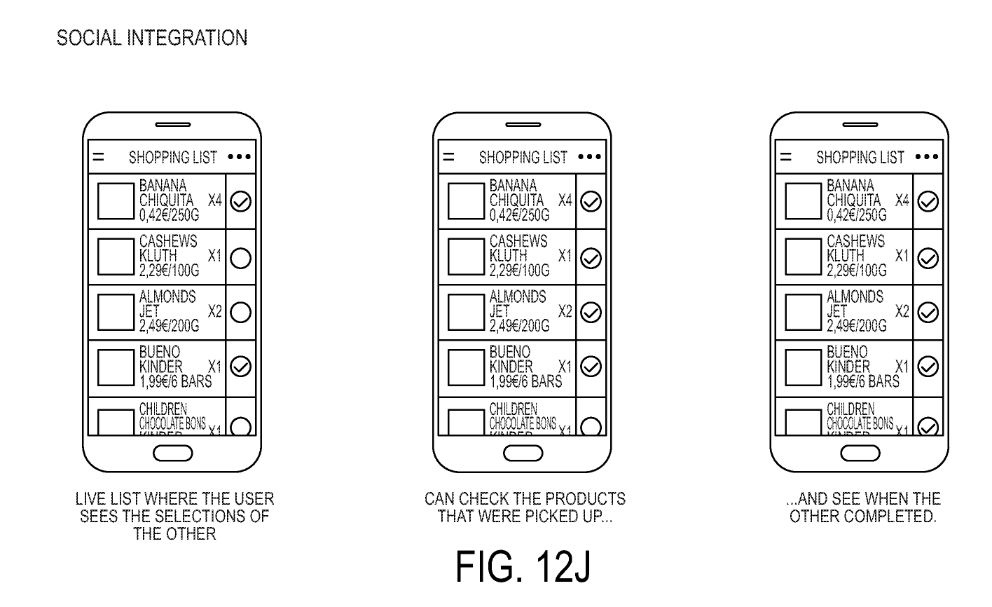

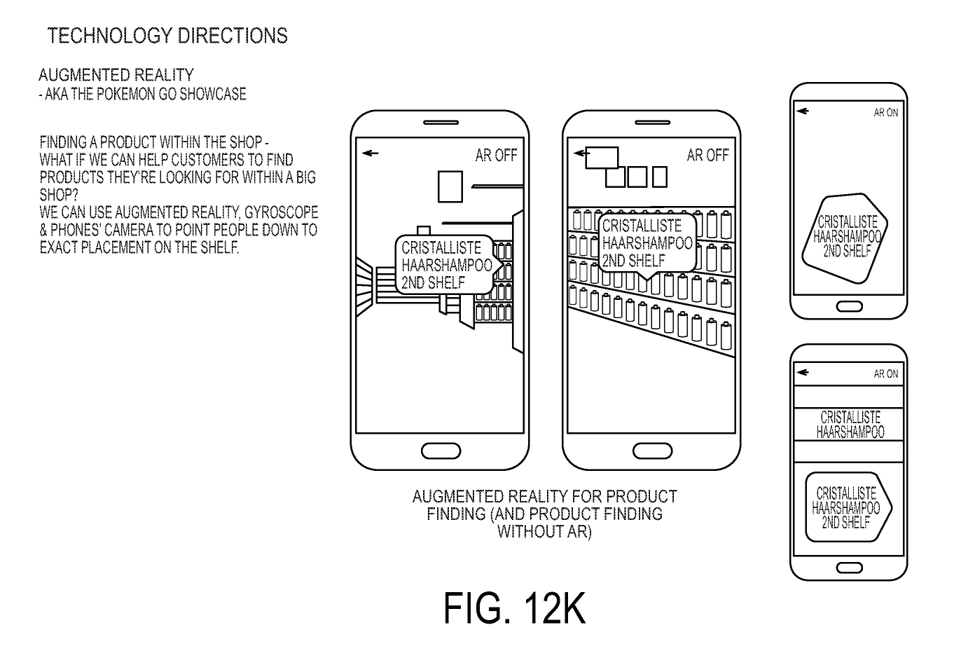

FIGS. 10A-10F, 11A-11D, and 12A-11K illustrate various example displays projected onto the mobile device and are self-explanatory.

While principles and modes of operation have been explained and illustrated with regard to particular embodiments, it must be understood, however, that this may be practiced otherwise than as specifically explained and illustrated without departing from its spirit or scope.

What is claimed is:

1. A server associated with a retailer, the server comprising:
a processor configured to receive an electronic list from a user that carries a mobile device within a store that is associated with the retailer;
a communication device adapted to communicate with the mobile device;
a product locator logic configured to locate items from the electronic list in the store;
a route determination logic configured to find a route to travel in the store passing the items in the electronic list;
an upsell logic configured to upsell the user depending on what products the user has scanned with the mobile device;
a warning logic configured to generate a warning message for display on the mobile device when the mobile device scans an item that is undesirable to the user; and
a checkout logic configured to sum scanned items and use payment information provided, at least in part, by the mobile device to process a payment for the items;
wherein the mobile device is configured to display the route within a map of the store to allow the user to follow the route to a location of the items in the electronic list.

2. The server of claim 1 wherein the mobile device is a cellphone.

3. A method for in store shopping including:
providing a server associated with a retailer;
receiving with the server a list of items;
determining with the server, locations of a plurality of the items within a store of the retailer; and
communicating the locations of the plurality of the items to a mobile device.

4. The method according to claim 3 further comprising:
determining a route to travel in the store based upon the locations determined; and
communicating the route to the mobile device.

5. The method of claim 4 wherein the communicating of the route includes transmission of data related to mapping of the plurality of items within the store.

6. The method of claim 3 further comprising:
summing the price of the plurality of items; and
communicating the sum calculated to the mobile device.

7. The method of claim 3 further comprising:
processing payment for the sum calculated based upon communication with the mobile device.

8. The method of claim 3 where the mobile device is associated with the store.

9. The method of claim 3 where the list is associated with a user.

10. The method of claim 9 further comprising:
evaluating the list based upon data associated with the user;
generating a message based upon that evaluation; and
sending the message to the mobile device.

11. The method of claim 10 where the message is related to a predicted desirability of at least one item on the list or a correlated item.

12. The method of claim 10 wherein the message includes a product recommendation.

13. A server associated with a retailer, the server comprising:
a processor configured to process a product locator logic based upon a list received to locate items from the list within a store of the retailor; and
a communication device adapted to communicate determined locations of items to a mobile device

14. The server of claim 13 where a location of the mobile device is associated with a location of the store of the retailer.

15. The server of claim 13 where the processer is configured to process a route determination logic to determine a route to travel in the store based at least in part upon the determined locations of items.

16. The server of claim 13 where the communication device is adapted to communicate map data of the determined location of items to the mobile device.

17. The server of claim 13 where the processor is configured to sum costs of a plurality of items from the list.

18. The server of claim 17 where the processor is configured to process a payment of the costs summed via a payment process associated with the mobile device.

19. The server of claim 13 where the mobile device is associated with a user and where the processor is configured to determine at least one product recommendation based at least in part upon data correlated to the user and at least one item from the list.
